(19) United States
(12) Patent Application Publication
(10) Pub. No.: US 2008/0075537 A1
(43) Pub. Date: Mar. 27, 2008

(54) In situ remediation

(76) Inventors: Alan George Seech, Naramata (CA); Evica Dmitrovic, Mississauga (CA); James Gregory Mueller, Freeport, IL (US)

Correspondence Address: Paul E Schaafsma;NovusIP, LLC, Suite 221, 521 West Superior Street, Chicago, IL, 60610-3135, US

(21) Appl. No.: 11/519,332

(22) Filed: Sep. 12, 2006

(51) Int. Cl. B09C 1/10

(52) U.S. Cl. 405/128.5

(57) ABSTRACT

A novel method of degrading, sequestering and/or immobilizing chemical contaminants in soil, sediment, or water is provided. The method comprises the addition of a sufficient amount of permanganate modified with a sufficient amount of an activator so as to destroy, sequester, and/or immobilize a detectable amount of the contaminants. In one aspect of the present invention, the permanganate and activator form a barrier or coating, composed of manganese oxides and components of the activator(s) that at least partially encapsulates a portion of the contaminant to minimize or prevent migration and/or dissolution of the contaminant. This encapsulation occurs via physical encrustation. The in situ remediation reagents of the present invention can be added to many contaminated environments including soil, sediment, rock, clay, water/groundwater and/or non-aqueous phase liquids.

### FIELD OF THE INVENTION

The present invention relates to compositions including modified permanganate materials and methods for remediation of environmental contamination using the same.

### BACKGROUND OF THE INVENTION

The use of permanganate salts, including NaMnO₄ and KMnO₄, as oxidants for soil remediation is well established. The use of permanganate salts for the purposes of in situ stabilization and flux reduction, however, has been limited. These limitations result from various factors associated with the chemistry of the process, such as for example a general inability to react with unsubstituted aliphatic hydrocarbons, the potential to generate secondary plumes (such as Manganese (Mn), Chromium (Cr), Arsenic (As)), and a need for excessive amount of reagents to treat environments with naturally elevated organic content/natural soil oxidant demand or a high level of contamination (free-phase hydrocarbons). This excessive amount of reagent translates into high cost.

Others have proposed to use alkaline earth metal bases to promote the stability of manganese dioxide precipitates; however, such an approach uses bases that are only slightly soluble, pose significant issues with respect to handling, and must be added in relatively large dosages (i.e., between 1% and 3% by weight of the soil undergoing treatment). Still others have proposed the use of various forms of carrier fluids composed of insoluble materials such as clays, cements, or other minerals along with limited amounts of water to create a suspension into which oxidant crystals are mixed. The object being to delay dissolution of the oxidant until it can be injected into the remediation zone. Such an approach is limited by the fact that injection and dispersal of the oxidant carried in an insoluble fluid material can be difficult and expensive.

What would thus be desirable is to provide an effective in situ treatment of soil, sediment, rock, clay, water/groundwater and/or non-aqueous phase liquid environments that are contaminated by high levels of organic compounds and/or inorganic compounds such as heavy metals without groundwater or soil removal. It would be further desirable to facilitate enhanced passive remediation and contraction of off-site plumes via flux reduction. It would be further desirable to provide a fast, cost-efficient liability management strategy. It would be further desirable for such treatment to be a minimally invasive and minimally disruptive to site operations. It would be further desirable to accelerate site closure resulting from the removal of residual targeted compounds. It would be further desirable to utilize materials that are easier to handle then the bases utilized in the prior art and are effective when employed at lower dosages. It would be further desirable to better inject and disperse materials relative to the difficulties of the prior art oxidant carried in an insoluble fluid material.

### SUMMARY OF THE INVENTION

In situ remediation in accordance with the principles of the present invention provides an effective in situ treatment of contaminated soil, sediment, rock, clay, water/groundwater, and/or non-aqueous phase liquid environments that are contaminated by high levels of organic compounds and/or inorganic compounds such as heavy metals without groundwater or soil removal. In situ remediation in accordance with the principles of the present invention facilitates enhanced passive remediation and contraction of off-site plumes via flux reduction. In situ remediation in accordance with the principles of the present invention provides a fast, cost-efficient liability management strategy. In situ remediation in accordance with the principles of the present invention is minimally invasive and minimally disruptive to site operations. In situ remediation in accordance with the principles of the present invention accelerates site closure resulting from the removal or containment of residual targeted compounds. In situ remediation in accordance with the principles of the present invention utilizes materials that are easier to handle then the bases utilized in the prior art and are effective when employed at lower dosages. In situ remediation in accordance with the principles of the present invention utilizes materials that are better injected and dispersed relative to the prior art oxidant carried in an insoluble fluid material.

In accordance with the present invention, a novel method of degrading, sequestering and/or immobilizing chemical contaminants in soil, sediment, or water is provided. The method comprises the addition of a sufficient amount of permanganate modified with a sufficient amount of an activator so as to destroy, sequester, and/or immobilize a detectable amount of the contaminants. In one aspect of the present invention, the permanganate and activator form a barrier or coating, composed of manganese oxides and components of the activator(s) that at least partially encapsulates a portion of the contaminant to minimize or prevent migration and/or dissolution of the contaminant. This encapsulation occurs via physical encrustation. The in situ remediation reagents of the present invention can be added to many contaminated environments including soil, sediment, rock, clay, water/groundwater and/or non-aqueous phase liquids.

### BRIEF DESCRIPTION OF THE DRAWINGS

FIG. 1 is a graph showing cumulative volume of solution that leached through 200 g of site soil after seven and eight days of treatment.

FIG. 2 is a graph showing changes in polycyclic aromatic hydrocarbons in leachate after eight days of treatment.

FIG. 3 is a graph showing changes in pentachlorophenol in leachate after eight days of treatment.

### DETAILED DESCRIPTION OF THE PREFERRED EMBODIMENTS

The present invention employs a stabilization composition that includes one or more permanganate activators in combination with a permanganate component to facilitate rapid oxidation and stabilization reactions. In accordance with the principles of the present invention, these compositions yield in situ chemical oxidation or stabilization (immobilization), or both of the “targeted compounds”. The stabilization composition of the present invention can be used for the prevention of contaminant migration and/or the treatment of existing contaminants by application of an activated permanganate solution. In one embodiment of the present invention, a permanganate component including one or more of sodium permanganate (NaMnO₄), potassium permanganate (KMnO₄) or other forms of permanganate, each having the general formula X₁₋₂(MnO₄)₁₋₂, where X can be a group 1 or 2 cation or any transition metal having a positive charge, can be used as a source of manganese oxide (MnO) or manganese dioxide (MnO₂).

The permanganate component is preferably modified with an activator to increase the rate or yield, or both, of one or more of the precipitation, sorption, and encrustation reactions associated with the formation of various manganese oxides including MnO₂ solids and mineral precipitates containing manganese oxides. Examples of activators in accordance with the invention can include one or more salts selected from a group consisting of transition metal salts, alkali metal salts, and alkaline earth metal salts. Additional examples of activators in accordance with the invention can include soluble silicates, such as sodium or potassium silicates. Combinations of the foregoing can also be used as activators in accordance with the invention. Preferably, the salts can be calcium or magnesium chlorides since they are relatively low in cost, have low environmental toxicity, and high aqueous solubility; however, a wide range of other salts are also believed to have utility as activators.

Examples of activators in accordance with the invention can include CaCl₂, FeCO₃, sodium silicate, and combinations thereof. Other minerals can be included in various combinations and proportions to provide known effects, such as increasing precipitation or sorption reactions, or changing the pH or buffering capacity of the activator(s). The activators can be provided as aqueous solutions or dissolved solids. Other suitable forms for the activator can include, but are not limited to slurries, pastes or any other flowable forms to facilitate flow of the activated permanganate into the zone of interest.

The modified solutions of permanganate facilitate stabilization of “targeted compounds”. These “targeted compounds” can include any contaminant or combination of contaminants typically requiring remediation. For example, typical “targeted compounds” can include petroleum based hydrocarbons (fossil fuel based materials); chlorinated organic compounds such as polychlorinated biphenyls (PCBs), solvents, pesticides, and the like; and heavy metals.

The stabilization composition can be added to any zone of interest for prevention or treatment of contamination via a number of methodologies such as, for example, subsurface injection, direct soil mixing, and the like. The zone of interest can include, for example, a section of soil, sediment, rock, clay, water/groundwater, non-aqueous phase liquid environments and/or the like, and/or any combination thereof. When added to contaminated environments, the in situ remediation of the present invention advantageously achieves one or more of the following: chemically degradation of targeted organic compounds; reduced soil, sediment, rock, and/or clay permeability and related water/groundwater and/or non-aqueous phase liquids flux; physical encrusting and encapsulation of residual targeted compounds with manganese dioxide (MnO₂) and other mineral precipitates; and precipitation or otherwise sequestration of inorganic targeted compounds such as heavy metals.

Preferably, an effective amount of stabilization composition will be introduced into a contaminated zone with contaminants to be treated, or introduced into a zone that may become contaminated to help prevent the contamination. Typically, this effective amount will be understood as a ratio of the amount of stabilization composition to the amount of volume or the level of contaminants to be remediated. Preferably, about 10 kg to 100 kg of stabilization composition can be administered to a zone having a volume of about 100 m³.

The stabilization composition may be introduced separately as the permanganate portion and the activator portion (examples include: salts and soluble silicates). When introduced separately, the first and second components can be introduced immediately one after the other or there can be a delay between the sequential addition of the components. Alternatively, the permanganate and activator can be combined first to form a stabilization composition before addition to the zone of interest. The stabilization composition can be introduced, either as a single component or separate components, in any manner suitable to apply a sufficient amount to remediate a detectable amount of contaminated material in the zone of interest. For example, the stabilization composition can be applied into soil, sediment, rock or clay, or into water or other solvent that is applied into groundwater that feeds into the contaminated zone, or any combination of application methods. The stabilization composition can be applied directly or indirectly to the contaminated zone. Other application methods might include introducing the permanganate and activator into a borehole or excavation in or adjacent the zone of interest containing contaminants.

In one embodiment, any type of stabilization component that includes manganese can be contacted with one or more contaminants in a zone of interest to remediate a portion of the contaminants. Preferably, but without being bound by theory, the stabilization component can form a manganese dioxide barrier coating that at least partially encapsulates a portion of one or more of the targeted contaminants to minimize or prevent migration or dissolution of the contaminants from the zone of interest.

While not limited to such, it is believed that the in situ remediation of the present invention will have special application to sites containing residual contaminants and/or free-phase, non-aqueous phase liquids such as for example refineries, former manufactured gas plant operations, and coking/wood treating/coal tar processing facilities. The stabilization composition of the present invention effectively facilitates the stabilization of various chlorinated solvents including for example perchloroethylene (PCE), trichloroethylene (TCE), and carbon tetrachloride (CT); further, stabilization of hydrocarbons (creosote) and chlorinated pesticides (e.g., pentachlorophenol (PCP)) has also been shown. It is believed that the stabilization composition of the present invention also helps stabilize certain metals via the enhanced precipitation reactions. In situ remediation with the present invention can also be applicable to environments that are naturally high in total oxidant demand because one or more of immobilization, encrustation, and flux reduction occurs as opposed to chemical oxidation alone.

It is believed that as the (X)MnO₄ reagents react with and destroy targeted compounds present as residual hydrocarbons, non-aqueous phase liquids, free-phase materials and/or dissolved materials, various reactions occur between the targeted compounds and the stabilization composition of the present invention. These reactions may be of a bio- or geo-chemical nature. It is believed that reactions between the targeted compounds and the stabilization composition of the present invention cause the destruction, removal, and/or stabilization of one or more of the targeted compounds. The chemical/biological oxidation reactions are believed to degrade or destroy contaminants of interest present in the dissolved phase. This, in turn, is believed to increase the release of contaminants of interest from non-aqueous phase liquids into the aqueous phase. The more water soluble, lower-molecular-weight constituents are dissolved and treated/removed at a proportionally higher rate, thus leading to a “hardening” or “chemical weathering” of the non-aqueous phase liquids as the non-aqueous phase liquid steadily loses its more labile components. This is believed to cause a net increase in viscosity of the organic material, which yields a more stable, recalcitrant residual mass that tends to leach fewer contaminants. As such, the flux of contaminants of interest released into the dissolved phase is much reduced.

In addition to contaminant destruction, the stabilization composition in accordance with the principles of the present invention is believed to physically stabilize non-aqueous phase liquid residuals via encapsulation, that is, the encrustation or the formation of a “shell” or crust around the targeted compound(s). At a pH range of 3 to 11, MnO₄ oxidation reactions tend to result in the formation of manganese dioxide (MnO₂) as follows:

MnO₄⁻+4H⁺+3e⁻→2H₂O+MnO₂₍ₛ₎

The MnO₂ precipitate is insoluble, has high surface area, is a good coagulant, and has high sorptive capacity for divalent cations. (See Pisarczyk, K. S. and L. A., and Rossi, “Sludge Odor Control and Improved Dewatering with Potassium Permanganate”, Carus Corporation, Peru, Ill. CX-4005 (1996)). Conventionally, this precipitate was considered problematic because of the potential for this solid to cause chemical fouling and reduction in aquifer permeability. (See Yin and Allen, “In Situ Chemical Treatment”, GWRTAC Technology Report TE-99-01 (1999)). Surprisingly, when occurring as a means of in situ source stabilization, in accordance with the invention, precipitation or encrustation is now considered desirable.

As such, in accordance with the principles of the present invention, new stabilization compositions have been developed that enhance the encrustation reactions and are thus effective in reducing aquifer permeability and encapsulating targeted compounds, thereby yielding comparatively rapid and effective in situ source management and flux reduction. It is believed that the (X)MnO₂ type crust precipitate forms along the non-aqueous phase liquid interface, physically encapsulating these liquids and thereby reducing the flux of dissolved-phase constituents into the water. Heavy metals will also participate in these desired precipitation reactions and can therefore also be immobilized.

The following are non-limiting examples, which illustrate the principles of the present invention.

### EXAMPLE 1

### Unmodified Permanganate Pilot-Scale Field Study

A pilot-scale field study was initiated at an operating wood-treatment facility where 24,050 gallons of 3% aqueous prior art permanganate (KMnO₄) solution (unmodified) were injected into 13 locations within a defined test area (75×95×10 ft deep). Performance monitoring was conducted for six months to evaluate the ability of the unmodified aqueous permanganate (KMnO₄) solution to destroy and reduce the flux from the free-phase, non-aqueous phase liquid residuals. Surprisingly, field data showed the stabilization of non-aqueous phase liquids. Mass was reduced by 11 to 79% (Table 1) and the flux of constitutes of interest was reduced by 49 to 98% (Table 2) (where PAH is polycyclic aromatic hydrocarbon).

TABLE 1
Mass Reduction following Treatment with an
Unmodified Aqueous Permanganate Solution.

| | Average (n = 4) | Average (n = 4) | % Mass |
|---|---|---|---|
| COI (mg/kg) | Background | Treated | Reduction |
| LMW PAHs | 7,633 | 5,996 | 21 |
| HMW PAHs | 1,961 | 1,744 | 11 |
| TOTAL PAHs | 9,595 | 7,771 | 19 |
| PENTA | 236.0 | 55.67 | 76 |
| TOTAL CPs | 284.5 | 59.25 | 79 |

TABLE 2
Flux Reduction following Treatment with an
Unmodified Aqueous Permanganate Solution.

| | Average (n = 4) | Average (n = 4) | % Flux |
|---|---|---|---|
| COI (mg/L) | Background | Treated | Reduction |
| LMW PAHs | 34.4 | 12.8 | 63 |
| HMW PAHs | 6.05 | 0.11 | 98 |
| TOTAL PAHs | 40.5 | 12.9 | 68 |
| PENTA | 18.9 | 9.66 | 49 |
| TOTAL CPs | 23.4 | 10.4 | 55 |

When additional studies were conducted with the unmodified aqueous permanganate (KMnO₄) solution, however, the results did not replicate this example. The variability in results (for example, 11% to 79%, Table 1) was also problematic; given that a reduction of 11% would not meet the remedial goal. It is believed that a unique characteristic of the soil at this operating wood-treatment facility may have by chance facilitated the observed variable stabilization reactions with the unmodified aqueous permanganate (KMnO₄) solution.

### EXAMPLE 2

### Comparative Laboratory Evaluations

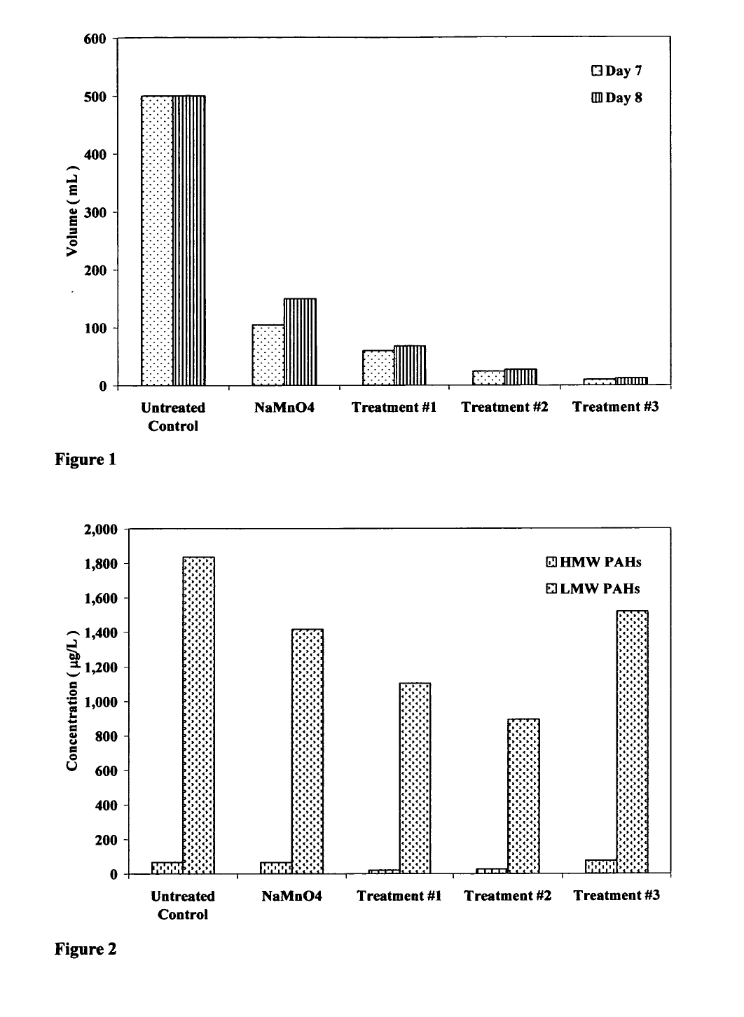

As described above, while the unmodified permanganate of the prior art was partially effective, apparently based on the unique characteristic of the soil at the tested site, the original unmodified permanganate was not effective when tested at various additional sites. Thus, activated permanganate (KMnO₄) stabilization reagents in accordance with the principles of the present invention were developed and tested. The experimental unit was a series of columns. Each system consisted of a Kontes glass column (2 inch internal diameter×6 inch long) (Fisher Scientific Company LLC, One Liberty Lane, Hampton, N.H. 03842) with 200 g of contaminated site soil. The appropriate solution (potassium permanganate or activated potassium permanganate or site water (control)) for each column was poured into the top of the column and allowed to drain via gravity. After only eight days treatment with stabilization reagents of the present invention, significant reductions in soil permeability and flux were observed, as seen in FIG. 1. The entire volume of 500 mL was collected from the untreated control; however, only 12 mL of leachate were collected from the activated permanganate #3 treatment and only 27 mL of leachate were collected from the activated permanganate #2 treatment. (In the Figures, the activated permanganate (KMnO₄) stabilization reagent is labeled as “Treatment”.) Using an unmodified permanganate solution of the prior art, minimal reduction in permeability of the soil was observed.

Following eight days of treatment, spring water was pumped into the column with a peristaltic pump and the effluent was sampled in duplicate for polycyclic aromatic hydrocarbons and chlorophenols. Referring to FIG. 2, the stabilization reagents of the present invention also yielded significant reductions in the amount of polycyclic aromatic hydrocarbons leached from the soils after only eight days of treatment. The average of duplicate analyses showed that a total of 1,904 μg total PAHs/L were leached from the untreated control. The lower-molecular-weight polycyclic aromatic hydrocarbons represented a majority of these constituents, and naphthalene was the primary contaminant of interest. Leachate from the activated permanganate treatment #2 contained an average of only 922 μg total PAHs/L. This represented a 52% reduction in leachable polycyclic aromatic hydrocarbons. When using unmodified solutions of permanganate of the prior art, the concentration of naphthalene and other lower-molecular-weight polycyclic aromatic hydrocarbons actually increased. Alternatively, use of the activated permanganate (KMnO₄) stabilization agent of the present invention reduced total lower-molecular-weight polycyclic aromatic hydrocarbons from an average of 1,836 to 894 μg/L. This same treatment (activated permanganate #2) reduced the concentration of higher-molecular-weight polycyclic aromatic hydrocarbons in leachate from an average of 69 to 28 μg/L, representing a surprising 60% reduction after only eight days of treatment.

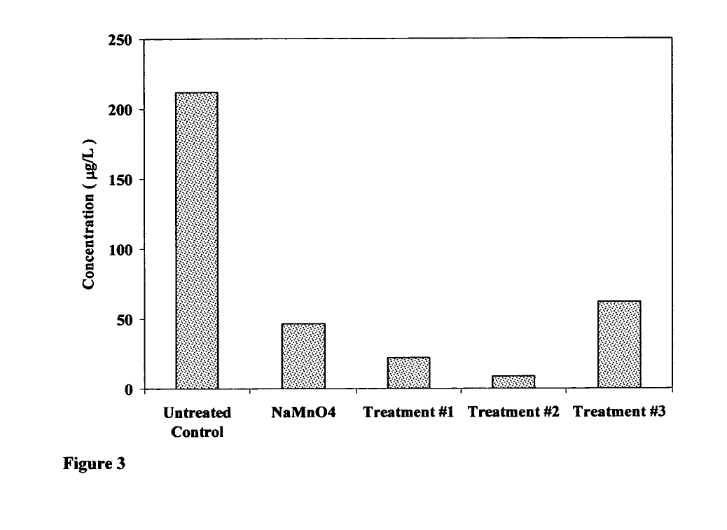

Referring to FIG. 3, similar results were observed with pentachlorophenol (PCP). The average of duplicate analyses showed that a total of 212 μg PCP/L were leached from the untreated control. In contrast, leachate from soil treated with activated permanganate treatment #2, in accordance with the present invention contained an average of only 9 μg PCP/L, representing a surprising 96% reduction in leachable constituent after only eight days of treatment with the activated permanganate (KMnO₄) stabilization agent of the present invention. Similar reductions were observed with other chlorinated pesticides.

Any leachate remaining in the columns was drained and soil samples were analyzed for residual contaminants of interest. Despite the tremendous reduction in contaminants leached from the columns treated with the activated permanganate of the present invention, there was little difference (i.e., 25% reduction) between the concentration or profile of polycyclic aromatic hydrocarbons or pesticides in soil from the untreated control column and either activated permanganate treatment. As noted above, however, the permeability of soil subjected to the activated permanganate treatments of the present invention was advantageously reduced along with the flux of targeted compounds from these treatments. This was especially true for soil subjected to treatment with activated permanganate treatment #2.

A mass balance of contaminants of interest was attempted by considering the mass of soil in each column (200 g wet weight, 172 g dry weight), the volume of pore water (from 110 to 165 mL/column), and the volume of leachate generated (3 L). These data showed that there was little difference in polycyclic aromatic hydrocarbons mass removal between treatments. Notably, the use of the activated permanganate (KMnO₄) stabilization agents of the present invention did not cause an increase in naphthalene, 3,4-dichlorophenol or any other constitutes of interest similar to that which was observed when using unmodified potassium based reagents.

### EXAMPLE 3

### Comparative Stabilization According to the Invention

Two columns were set up for an in situ activated permanganate study (Table 3) in accordance with the principles of the present invention.

TABLE 3
Summary of Column Testing

| Column ID | Description | Solution |
|---|---|---|
| 1 | Activated Permangante | NaMnO₄ + additives |
| 2 | Control | Site Groundwater |

Each system consisted of a glass column (2 inch internal diameter×12 inch long) with 1 inch of clean sand (Fisher Scientific Company LLC, One Liberty Lane, Hampton, N.H. 03842) at the base followed by 200 g of spiked site soil. A peristaltic pump dedicated to each column was used to recirculate 1 L of the appropriate solution through each column. Column #1 received the activated permanganate (NaMnO₄) stabilization solution of the present invention, whereas column #2 received only site groundwater to serve as a control. After continuously recirculating solutions through the columns for 10 days in an up-flow mode at a flow rate of about 150 mL/day, the columns were disconnected from their respective pumps, and the liquid was drained via gravity. The rate of drainage was recorded as an indicator of soil permeability/transmissivity.

The initial drainage water collected from the columns was analyzed for semi-volatile organic compounds and benzene, toluene, ethylbenzene, and xylene. After this analysis, the tops of the columns were opened and a total of 3 L of spring water was added in an effort to gently flush any residual permanganate from the soil, to minimize or avoid interference with subsequent analysis of the crust. The spring water drained from the columns via gravity and the general rate was recorded.

Following the drainage of the spring water from the columns, the soil in the columns was removed and examined. The soil from the activated permanganate column was removed and divided into four sections. Section 1 consisted of the clean sand at the base of the column. Sections 2, 3, and 4 were the bottom, middle, and top layers of the site soil, respectively. Observations of the soil were made and a composite sample from Sections 2, 3, and 4 was analyzed for semi-volatile organic compound; benzene, toluene, ethylbenzene, and xylene analyses; and manganese.

After 10 days, about a 60% reduction in permeability was observed in the columns subjected to the remediation treatment of the present invention. The volume of liquid drained from the activated permanganate column was 40 mL and 80 mL after 15 and 30 minutes, respectively. During the same time periods, 124 mL and 222 mL were drained from the untreated control column.

The column effluent subjected to the remediation treatment of the present invention had a higher concentration of semi-volatile organic compounds than the control column effluent (see Table 4 where SVOC is semi-volatile organic compound and BTEX is benzene, toluene, ethylbenzene, and xylene). However, the main contaminant of concern in the column effluent subjected to the remediation of the present invention was benzoic acid at a concentration of 3,100 ppb. If this compound is excluded from the total, then there is little difference between the two columns in terms of leachable semi-volatile organic compounds. This was somewhat unexpected as there is typically a decrease in the amount of semi-volatile organic compounds in the aqueous phase of the columns with the remediation of the present invention.

As noted above, however, the initial column drainage water was the material analyzed. Hence, it appears that the contaminants of interest were likely in equilibrium with the pore water and not all areas of the soil in the column were fully encrusted at the time of sampling (i.e., crusting was generally limited to the lower half of the treatment column).

TABLE 4
SVOC and BTEX Concentrations in
Initial Column Effluent

| | Activated | |
|---|---|---|
| | Permanganate | |
| | Column | Control Column |
| SVOC (ppb) | | |
| Benzoic Acid | 3,100 | ND (30) |
| Naphthalene | 81 | 0.82 |
| 2-Methylnaphthalene | ND (0.77) | ND (0.75) |
| Acenaphthylene | ND (1.5) | 21 |
| Acenaphthene | ND (1.5) | 11 |
| Dibenzofuran | 13 | ND (3) |
| Fluorene | ND (1.5) | 10 |
| Phenanthrene | 54 | 4.6 |
| Anthracene | 1.6 | 3.6 |
| Carbazole | ND (7.7) | ND (7.5) |
| Fluoranthene | 13 | 8.7 |
| Pyrene | 32 | 12 |
| Benzo(a)anthracene | ND (0.31) | 1.8 |
| Chrysene | 6 | 1.5 |
| Benzo(b)fluoranthene | 6.7 | 0.97 |
| Benzo(k)fluoranthene | 3.4 | ND (0.30) |
| Benzo(a)pyrene | ND (0.31) | 1.2 |
| Indeno(1,2,3-cd)pyrene | ND (0.31) | 0.51 |
| Dibenzo(a,h)anthracene | ND (0.46) | ND (0.45) |
| Benzo(ghi)perylene | ND (1.5) | 0.72 |
| Total SVOC | 3,311 | 78.42 |
| BTEX (ppb) | | |
| Benzene | 15 | 1.4 |
| Toluene | ND (1) | 1.9 |
| Ethylbenzene | ND (1) | ND (1) |
| Xylene (total) | ND (2) | 48 |
| Total BTEX | 15 | 51 |

The total concentration of benzene, toluene, ethylbenzene, and xylene was 15 ppb and 51 ppb in the effluents from the column subjected to the activated permanganate treatment of the present invention and the control column, respectively. In response to 10 days of in situ remediation treatment, the total semi-volatile organic compound concentration in the soil remediated in accordance with the present invention was reduced from 3,963,400 ppb to 1,439,200 ppb (see Table 5). This corresponded to a 64% reduction in total semi-volatile organic compounds. The total concentration of benzene, toluene, ethylbenzene, and xylene in the soil was reduced from 49,500 ppb to 19,800 ppb, reflecting a 60% reduction in total benzene, toluene, ethylbenzene, and xylene.

TABLE 5
Influence of Activated Permanganate Stabilization Agent
on SVOC, BTEX, and Mn Concentrations in Soil

| | | Activated |
|---|---|---|
| | | Permanganate |
| | Initial Soil | Treated Soil |
| SVOC (ppb) | | |
| Benzoic Acid | ND (28,000) | ND (40,000) |
| Naphthalene | 970,000 | 200,000 |
| 2-Methylnaphthalene | 640,000 | 150,000 |
| Acenaphthylene | 240,000 | 100,000 |
| Acenaphthene | 100,000 | 93,000 |
| Dibenzofuran | 18,000 | 24,000 |
| Fluorene | 220,000 | 45,000 |
| Phenanthrene | 690,000 | 160,000 |
| Anthracene | 160,000 | 43,000 |
| Carbazole | 6,900 | 2,000 |
| Fluoranthene | 200,000 | 59,000 |
| Pyrene | 280,000 | 86,000 |
| Benzo(a)anthracene | 96,000 | 120,000 |
| Chrysene | 91,000 | 85,000 |
| Benzo(b)fluoranthene | 66,000 | 53,000 |
| Benzo(k)fluoranthene | 33,000 | 55,000 |
| Benzo(a)pyrene | 85,000 | 80,000 |
| Indeno(1,2,3-cd)pyrene | 26,000 | 34,000 |
| Dibenzo(a,h)anthracene | 6,500 | 8,200 |
| Benzo(ghi)perylene | 35,000 | 42,000 |
| Total SVOCs | 3,963,400 | 1,439,200 |
| BTEX (ppb) | | |
| Benzene | ND (31) | ND (31) |
| Toluene | 7,500 | 1,000 |
| Ethylbenzene | 15,000 | 7,800 |
| Xylene (total) | 27,000 | 11,000 |
| Total BTEX | 49,500 | 19,800 |
| METALS | | |
| Manganese | 74 | 4,100 |

As expected, an increase in the manganese concentration was observed in the soil subjected to treatment with the activated permanganate of the present invention, which indicated that manganese dioxide precipitates (a byproduct of the oxidation of the contaminant of concern with MnO₄) were produced. Given that the NaMnO₄ in the in situ remediation solution was not fully consumed after the 10 day treatment period, further degradation of contaminants of interest would be expected with a longer treatment period or with a fresh infusion of activated permanganate component according to the invention. Visual observations of the soil revealed that the soil in the column subject to the activated permanganate treatment of the present invention was darker in color than that of the control. In addition, the individual sand grains in the soil from the activated permanganate column appeared to be “cemented” together. This further supports the expected encapsulation (crusting) and stabilization of contaminants in the soil, as well as the decrease in soil permeability for treatments in accordance with the principles of the present invention.

A mineral crust, presumably dominated by MnO₂ was visually apparent in the activated permanganate treated columns. As described above, this crusting is the main mechanism of encapsulation. This crust was extracted and sent for external analysis to observe particle formations and heterogeneities. This was accomplished via a combination of Scanning Electron Microscopy and X-ray photoelectron spectroscopy, also known as electron spectroscopy for chemical analysis. X-ray photoelectron spectroscopy is a surface analysis technique that uses photoelectrons generated by an x-ray beam to analyze the composition and chemistry of the outermost ˜50 Å of the surfaces of samples. This was used to help determine the quantitative elemental composition of MnO₂ surfaces, molecular species present on surfaces, and chemical states of surface atoms.

The results of these experiments, and particularly the conclusions or suggestions, are theories that are not binding or limiting on the scope of the invention. Rather, they suggest areas for further scientific study as described below.

Eight soil samples identified in Table 6 below were collected from the treatment and control columns and tested:

TABLE 6
Samples

| Internal Sample ID | Description |
|---|---|
| 42028 | Bottom sand of treatment column |
| 42029 | Front interface of treatment column |
| 42030 | Middle section of treatment column |
| 42031 | Top section of treatment column |
| 42250 | Bottom of control column |
| 42251 | Lower middle of control column |
| 42252 | Upper middle of the control column |
| 42253 | Top of the control column |

The specimens from both batches were dried in a fume hood. Small quantities of soil were then placed on a clean filter paper and picked up on double sided conductive tape stuck to the Scanning Electron Microscopy specimen mount. Excess material was removed by gently blowing compressed air across the face of the mount. The samples were observed with a Hitachi S-3000N Variable Pressure Microscope (available from Hitachi, Ltd., Tokyo, Japan) operated in high vacuum with accelerating voltages of 5 kV, 10 kV or 20 kV. The higher accelerating voltages were used for X-ray photoelectron spectroscopy analysis, the lower values for surface sensitive imaging. The control specimens were reviewed at 20 kV only.

After screening the eight soils, four samples (2 treated and 2 controls) were selected for more detailed analysis. Each of these samples was analyzed in duplicate. The samples from the in situ remediation treated specimens were sample 42029 and 42030. Sample 42029 consisted of soil recovered from the lower portion of the treated column and was the most thoroughly encrusted sample. Scanning Electron Microscopy showed a near uniform level of manganese coating throughout the analyzed regions of this sample.

Elemental analysis of these surfaces showed that the deposited minerals contained high proportions of iron, calcium, sodium, manganese, and silica. It was also apparent that these elements formed complexes such as iron-manganese and other oxides in the soil treated with the activated permanganate of the present invention.

The soil samples collected from the middle of the untreated control columns (42251 and 42252) exhibited only a thin coating or encrustation. Notably, smoother surface areas on soil particles were a ubiquitous feature of the untreated control soil.

Significantly, the control soils contained no detectable manganese. In general, the particle surfaces were smooth and did not exhibit the encrusted features, elemental distribution, or mineral complexes described for the activated permanganate treated soil (42029).

### CONCLUSIONS

Within 10 days of treatment, the use of activated permanganate in accordance with the principles of the present invention yielded the following results with contaminated soils:
The concentrations of various constituents of interest in soil were reduced. Namely, polycyclic aromatic hydrocarbon concentrations were reduced by 64%, and benzene, toluene, ethylbenzene, and xylene concentrations were reduced by 60%.
A “crust” was generated which hardened the organic residuals in the soil treated in accordance with the principles of the present invention. Despite the presence of many elements as naturally occurring soil minerals, the crust was only generated in the presence of the activated permanganate (NaMnO₄) stabilization agent of the present invention;
Physical and chemical characterization of the crust showed that it was uniformly distributed over the treated soil particles, and that it consisted of modified iron-manganese dioxides containing the added activators; and
The permeability of the soils treated in accordance with the principles of the present invention was advantageously reduced by at least 60%.

The presence of a post-treatment crust in the contaminated soils was indicated by the following:

Reductions in permeability during course of the experiment

Reductions in the concentrations of constituents of interest

X-Ray photoelectron spectroscopy to quantify MnO₂ crust composition

Polarized light microscopy and X-Ray Diffraction; and

Other visual observations.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A method for remediating a contaminated zone comprising:
introducing a predetermined amount of permanganate into the contaminated zone; and
introducing an activator selected from the group consisting of alkaline earth salts, alkali salts, transition metal salts, inorganic salts, organic salts, soluble silicates, and combinations thereof into the contaminated zone;
wherein the predetermined amounts of permanganate and activator are sufficient to combine and remediate a detectable amount of contaminants in the zone;

2. The method for remediating a contaminant of claim 1 further including adding the activator before adding the permanganate.

3. The method for remediating a contaminant of claim 1 further including adding the activator after adding the permanganate.

4. The method for remediating a contaminant of claim 1 further including adding the permanganate simultaneously with the activator.

5. The method for remediating a contaminant of claim 1 further including mixing the permanganate and the activator in-situ.

6. The method for remediating a contaminant of claim 1 further including mixing the permanganate and the activator ex-situ.

7. The method for remediating a contaminant of claim 1 further including mixing the permanganate and the activator and subsequently placing the mixed permanganate and activator into an excavation in the subsurface.

8. The method for remediating a contaminant of claim 1 further including mixing the permanganate and the activator and subsequently placing the mixed permanganate and activator into a borehole in the subsurface.

9. The method for remediating a contaminant of claim 1 further wherein the permanganate comprises solid sodium permanganate (NaMnO₄).

10. The method for remediating a contaminant of claim 1 further wherein the permanganate comprises liquid potassium permanganate (KMnO₄).

11. The method for remediating a contaminant of claim 1 further including selecting the activator from the group consisting of CaCl₂, FeCO₃, Na₂SiO₂, other soluble silicates, and combinations thereof.

12. The method for remediating a contaminant of claim 1 further including selecting the contaminant from the group consisting petroleum based hydrocarbons, chlorinated organic compounds, heavy metals, pesticides, and combinations thereof.

13. The method for remediating a contaminant of claim 1 further including remediating contaminants from the group consisting of soil, sediment, rock, clay, water/groundwater, non-aqueous phase liquid environments, and combinations thereof.

14. The method for remediating a contaminant of claim 1, wherein the remediation comprises stabilizing a contaminant.

15. The method for remediating a contaminant of claim 14 wherein the stabilizing comprises physically encrusting and encapsulating the contaminant such that leaching of the contaminant is inhibited or minimized.

16. The method for remediating a contaminant of claim 14 wherein the encrustation comprises a manganese oxide barrier coating.

17. The method for remediating a contaminant of claim 1 further wherein the remediation occurs by chemical oxidation.

18. The method for remediating a contaminant of claim 1 further including introducing a predetermined amount of permanganate having the general formula X₁₋₂ (MnO₄)₁₋₂, where X can be a group 1 or 2 cation or any transition metal having a positive charge.

19. A method for remediating a contaminant comprising introducing into contaminated material activated permanganate to enhance a myriad of precipitation, sorption, and encrustation reactions associated with the accelerated and enhanced formation of manganese oxide and manganese dioxide materials.

20. The method for remediating a contaminant of claim 19 further including placing the activated permanganate into an excavation in the subsurface.

21. The method for remediating a contaminant of claim 19 further including placing the activated permanganate into a borehole in the subsurface.

22. The method for remediating a contaminant of claim 19 further wherein the activated permanganate comprises solid sodium permanganate (NaMnO₄).

23. The method for remediating a contaminant of claim 19 further wherein the activated permanganate comprises liquid potassium permanganate (KMnO₄).

24. The method for remediating a contaminant of claim 19 further including activating the permanganate with a material selected from the group consisting of alkaline earth salt, iron carbonate, soluble silicate, and combinations thereof.

25. The method for remediating a contaminant of claim 24 further including activating the permanganate with a material selected from the group consisting of CaCl₂, FeCO₃, Na₂SiO₃, and combinations thereof.

26. The method for remediating a contaminant of claim 19 further including treating a contaminant selected from the group consisting of petroleum based hydrocarbons, chlorinated organic compounds, heavy metals, pesticides, and combinations thereof.

27. The method for remediating a contaminant of claim 19 further including remediating contaminants selected from the group consisting of soil, sediment, rock, clay, water/groundwater, non-aqueous phase liquid environments, and combinations thereof.

28. A material to remediate a contaminant comprising a formulation of a sufficient amount of permanganate modified with a sufficient amount of activator and used as a source of manganese oxides.

29. The material to remediate contaminant of claim 28 further wherein the material comprises solid sodium permanganate (NaMnO₄).

30. The material to remediate contaminant of claim 28 further wherein the material comprises liquid potassium permanganate (KMnO₄).

31. The material to remediate contaminant of claim 28 further wherein the activator is selected from the group consisting of alkaline earth salt, iron carbonate, soluble silicate, and combinations thereof.

32. The material to remediate contaminant of claim 31 further wherein the activator is selected from the group consisting of CaCl₂, FeCO₃, Na₂SiO₂, and combinations thereof.

33. The material to remediate contaminant of claim 28 further wherein the contaminant is selected from the group consisting of petroleum based hydrocarbons, chlorinated organic compounds, heavy metals, pesticides, and combinations thereof.

34. The material to remediate contaminant of claim 28 further wherein contaminants are remediated from the group consisting of soil, sediment, rock, clay, water/groundwater, non-aqueous phase liquid environments, and combinations thereof.

35. A method for remediating a contaminant comprising contacting an effective amount of a stabilization composition comprising manganese to the contaminant so as to form a manganese oxide barrier that at least partially encapsulates a portion of the contaminant to minimize or prevent migration and/or dissolution of the contaminant.

36. The method for remediating contaminants of claim 35 further wherein the stabilization composition comprises permanganate.

37. The method for remediating contaminants of claim 36 further wherein the permanganate comprises solid sodium permanganate (NaMnO₄).

38. The method for remediating contaminants of claim 36 further wherein the permanganate comprises liquid potassium permanganate (KMnO₄).

39. The method for remediating contaminants of claim 35 further wherein the stabilization composition comprises permanganate and an activator.

40. The method for remediating contaminants of claim 39 further wherein the activator is selected from the group consisting of alkaline earth salt, iron carbonate, soluble silicate, and combinations thereof.

41. A stabilization composition comprising:
a sufficient amount of permanganate material including one or more permanganates having the general formula X₁₋₂(MnO₄)₁₋₂ where X can be a group 1 or 2 cation or any transition metal having a positive charge; and
a sufficient amount of an activator comprising one or more salts and soluble silicates, and combinations thereof;
wherein the amounts are sufficient to remediate a contaminant.

42. The stabilization composition of claim 41 further wherein the one or more salts is selected from the group comprising transition metal salts, alkali metal salts, alkaline earth metal salts, and combinations thereof.

43. The stabilization composition of claim 41 further wherein the soluble silicates are selected from the group comprising potassium silicate, sodium silicate, and combinations thereof.

44. The stabilization composition of claim 41 further wherein the stabilization composition inhibits or prevents leaching of the contaminant.

45. The stabilization composition of claim 41 further wherein the permanganate material is selected from the group consisting of sodium permanganate (NaMnO₄), potassium permanganate (KMnO₄), and combinations thereof.

46. The stabilization composition of claim 41 further wherein the stabilization composition is provided in the subsurface.

47. The stabilization composition of claim 41 further wherein the activator is selected from the group consisting of CaCl₂, FeCO₃, Na₂SiO₂, and combinations thereof.

48. A stabilization composition of claim 41 further wherein the contaminant is selected from the group consisting of petroleum based hydrocarbons, chlorinated organic compounds, heavy metals, pesticides, and combinations thereof.

49. A stabilization composition of claim 41 further wherein contaminants are selected from the group consisting of soil, sediment, rock, clay, water/groundwater, non-aqueous phase liquid environments, and combinations thereof.
